(19) United States
(12) Patent Application Publication
(10) Pub. No.: US 2017/0371950 A1
(43) Pub. Date: Dec. 28, 2017

(54) METHOD FOR THE MANAGEMENT OF VIRTUAL OBJECTS CORRESPONDING TO REAL OBJECTS, CORRESPONDING SYSTEM AND COMPUTER PROGRAM PRODUCT

(71) Applicant: AD2014 S.R.L., Torino (IT)

(72) Inventors: Amedeo PERNA, Torino (IT); Marco ABRATE, Torino (IT); Stefano BARBERO, Torino (IT); Umberto CERRUTI, Torino (IT); Nadir MURRU, Torino (IT)

(21) Appl. No.: 15/543,278

(22) PCT Filed: Jan. 15, 2016
(86) PCT No.: PCT/IB2016/050202

§ 371 Date: Jul. 13, 2017

(30) Foreign Application Priority Data
Jan. 16, 2015 (IT) TO2015A000040

(51) Int. Cl. G06F 17/30; G06F 7/58; G06F 7/72; G06Q 30/06

(52) U.S. Cl. CPC G06F 17/30598; G06F 17/30876; G06F 7/586; G06F 7/721; G06Q 30/0623

(57) ABSTRACT

A method for managing virtual objects (O) corresponding to real objects (R), said virtual objects (O) comprising a set (OP) of information or data representing said real object (R), said virtual objects (0) residing in a management system (20), which comprises a computer system (21) accessible by user terminals (13) through a telecommunication network to enable operations to be carried out on said virtual objects (O) in a database (22a) in said computer system (21), said method comprising the operations of: generating (100), in response to a request of a requesting subject (C) to create one or more virtual objects (O) that represent respective real objects (R), corresponding unique identifier codes (Z, z_{x, c, i}) that enable a user terminal (13) to carry out operations on the respective virtual object (O). According to the invention, said unique identifier codes (z_{x, c, i}) enable a user terminal (13) to carry out a procedure of activation of the respective virtual object (O) by associating in the database (22a) comprised in said computer system (21) a unique identifier code (Z, (Z, z_{x, c, i}) to a first basic set (BP) of information supplied by said owning subject (C) at the moment of the request, said identifier code (z_{x, c, i}) being calculated on the basis of: a first value (X) identifying a class to which the virtual object belongs (O); a second value (C) identifying said requesting subject; and a third value (i) representing a label that identifies said virtual object (0) in said class (X).

### TECHNICAL FIELD

The present disclosure relates to techniques for managing virtual objects that correspond to real objects, the virtual objects comprising a set of information or data representing the real object, the virtual objects residing in a management system comprising a computer system accessible by user terminals through a telecommunication network to enable operations to be carried out on the virtual objects in a database in the computer system, the method comprising the operations of generating, in response to a request of a requesting subject to create one or more virtual objects representing respective real objects, corresponding unique identifier codes that enable a user terminal to operate on the respective virtual object.

Various embodiments may be applied to the management of virtual objects that represent real objects put on sale by clients of a virtual-object management system and sold to users.

### TECHNOLOGICAL BACKGROUND

It is in general known to create virtual objects that constitute the representation of real objects. For this purpose, virtual representations are created, frequently referred to as “avatars”, associated to which are information and data in various formats so as to create a representation of the real object. This representation may comprise parameters that describe the real object, such as image files, data on parameters of a technical, physical, chemical, or other nature, according to the object, but also data that describe the history of the object and other data that extend in some way representation of the object beyond what may be perceived by observing the corresponding real object.

In this framework, it is known, for example, to create virtual objects corresponding to real objects put on sale.

However, a problem that is posed in this context is to define a modality for enabling the subject who possesses the real object, for example, because he has purchased it from a producer or from a distributor, to operate on the virtual object, i.e., on the data structure through a computer system that contains the information regarding the virtual object.

It is possible to adopt identifier codes to be associated to the objects, which, however, must enable unique identification of the object.

### OBJECT AND SUMMARY

The object of the embodiments described herein is to improve the potential of the methods according to the prior art as discussed previously.

Various embodiments achieve the above object thanks to a method having the characteristics recalled in the ensuing claims. Various embodiments may also refer to corresponding systems, as well as to a computer program product, which can be loaded into the memory of at least one computer (e.g., a terminal in a network) and comprises portions of software code suited for executing the steps of the method when the program is run on at least one computer. As used herein, the computer program product is understood as being equivalent to a computer-readable means containing instructions for controlling the computer system so as to co-ordinate execution of the method according to the invention. Reference to “at least one computer” is intended to emphasize the possibility of the present invention being implemented in a modular and/or distributed form. The claims form an integral part of the technical teachings provided herein in relation to the invention.

### BRIEF DESCRIPTION OF THE DRAWINGS

Various embodiments will now be described, purely by way of example, with reference to the annexed drawings, wherein:

FIG. 1 shows a block diagram that represents a virtual-object management system that implements the method according to the invention;

FIG. 2 is a schematic representation of a virtual object that is accessed using the method according to the invention;

FIG. 3 shows a flowchart representing a procedure of activation of the virtual object of FIG. 2;

FIG. 4 shows a block diagram that illustrates the architecture of the virtual-object management system of FIG. 1; and

FIGS. 5, 6, and 7 show flowcharts illustrating a code-assignment procedure according to the invention.

### DETAILED DESCRIPTION

In the ensuing description numerous specific details are given to enable maximum understanding of the embodiments provided by way of example. The embodiments may be implemented with or without specific details, or else with other methods, components, materials, etc. In other circumstances, structures, materials, or operations that are well known are not illustrated or described in detail so that various aspects of the embodiments will not be obscured. Reference, in the course of the present description, to “an embodiment” or “one embodiment” means that a particular structure, peculiarity, or characteristic described in relation to the embodiment is comprised in at least one embodiment. Hence, phrases such as “in an embodiment” or “in one embodiment” or the like that may appear in various points of the present description do not necessarily refer to one and the same embodiment. Furthermore, the particular structures, peculiarities, or characteristics may be combined in any convenient way in one or more embodiments.

The notation and references are provided herein merely for convenience of the reader and do not define the scope or the meaning of the embodiments.

In general, the method regards management of virtual objects corresponding to real objects, the virtual objects comprising a set of information or data representing the real object and residing in a management system implemented in a computer system accessible by user terminals through a telecommunications network to enable operations to be carried out on the virtual objects, which are hosted in a database in the computer system. In this framework, it is envisaged to generate, in response to a request from a subject, in particular a producer or dealer or seller of real objects, one or more virtual objects representing respective real objects, corresponding unique identifier codes that enable a user terminal, which is used, for example, by the end customer of the object, to operate on the respective virtual object.

The above unique identifier codes enable a user terminal to execute a procedure of activation of the respective virtual object, associating in the database a unique identifier code to a first basic set of information supplied by the requesting subject at the moment of the request.

The identifier code is calculated on the basis of:

a first value X identifying a class to which the virtual object belongs;

a first value C identifying the requesting subject; and

a third value i representing a label that identifies the above virtual object in the aforesaid class.

In various embodiments, the first, second, and third values are made available in the management system, in a data structure that preferably does not correspond to the database of the virtual objects, as potential virtual objects before an activation procedure creates the effective virtual object in the database following upon reception of the identifier code.

The first value X identifying a class to which the virtual object belongs is generated when the requesting subject C, e.g., a requesting firm purchases, for example, from the management system a given lot of identifier codes, i.e., a plurality of identifier codes for identifying a plurality of corresponding virtual objects.

The second value C identifying the requesting subject is preferably assigned at the moment of subscription to the service of the management system by a requesting subject, for example, a requesting firm that produces real objects that it wishes to be represented by virtual objects.

The third value i representing a label that identifies the above virtual object in the aforesaid class is generated internally by the management system to number, for example, the identifier codes of a given lot of virtual objects.

The above virtual object is hence managed by a respective management system, which, for example, may have a structure that, in order to be easily scalable and modifiable, may be of a modular type, with modules that are as independent as possible of one another and that communicate “messages” via a call system. In this framework, a macro-division may be made between the software that handles the macro-data (back-end) of the virtual objects, of the clients, and of the users, and the interfaces that consume the macro-data (front-end), i.e., that make available the data to the users, in addition to receiving their requests or queries. The communications between the parties are made through APIs (Application Programming Interfaces), preferably RESTful APIs (REST: REpresentational State Transfer). The subjects that interact with the management method or system include the subjects that generate the APIs (API servers), such as programmers/developers, and the subjects that consume them (clients/front-end). In order not to have any limitation on the number of subjects, it is useful to have an unlimited number of both servers and clients. To obtain this, the management system may be based entirely on a cloud-computing system, and more specifically the Amazon system through Amazon Web Services (AWS).

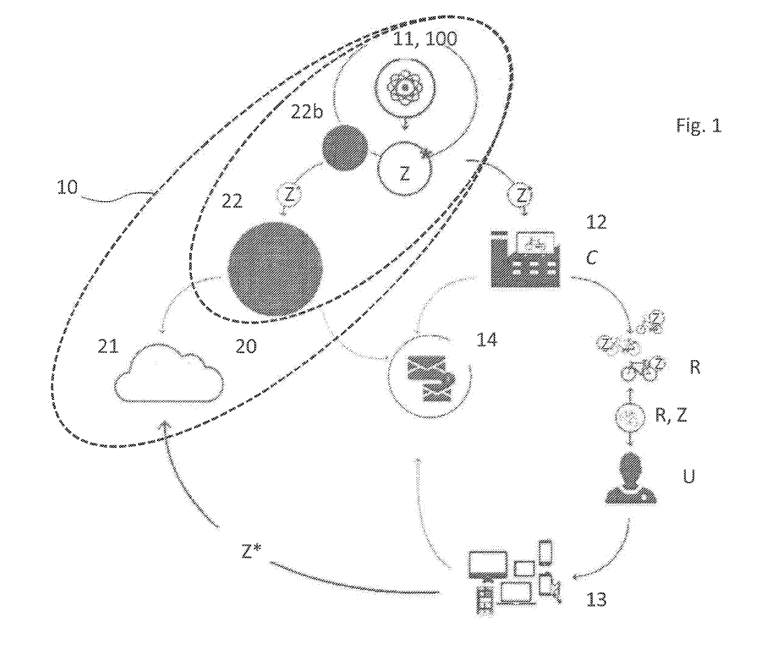

In greater detail, illustrated schematically in FIG. 1 is a system 10 for management of virtual objects O corresponding to real objects R that are distributed via a distributor C, or seller, to users U. Preferably, the distributor C is a producer or seller of real objects R, or goods, for instance, vehicles, watches, or artworks, such as paintings or sculptures, to exemplify real objects R from the best suited for the application of the method described herein. Of course, the method described herein may be applied to any real object R suited to being represented via a corresponding virtual object O, in particular, but not exclusively, to marketable objects. The distributor C, or seller, or producer, of real objects hence forms part of a category of subjects that ask the management system 10 to generate virtual objects representing respective real objects and corresponding unique identifier codes for enabling a user terminal to activate/access the aforesaid virtual objects.

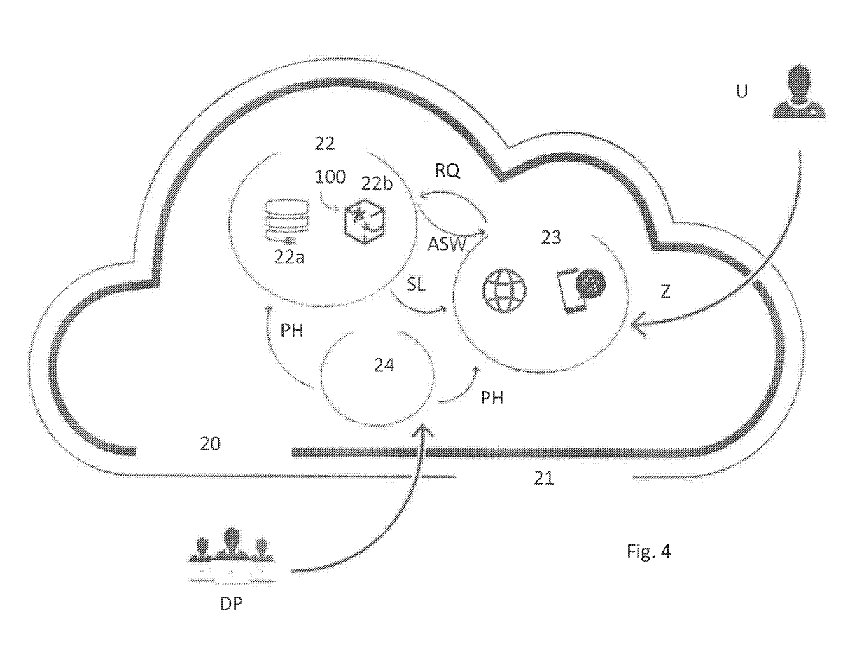

This system 10 for management of virtual objects O representing real objects R preferably resides in a computer system in the form of cloud computing, for example, of the AWS-cloud type, designated by the reference number 21. Residing within this computer system 21 is a system 20 for access to the virtual objects O, present, in particular, in a database 22a, as explained in greater detail in what follows with reference to FIG. 4.

Designated by 11 is a module for generating a code identifying the virtual object O, designated as a whole by Z. This generation node 11 is preferably implemented in the access system 20, via the computer system 21, in particular of the cloud-computing type, so as to carry out generation of the identifier codes Z off-line, i.e., in response to a request from a requesting subject, in particular a producer or dealer of real objects, to create one or more virtual objects representing respective real objects and corresponding unique identifier codes that enable a user terminal, which is used, for example, by the end customer of the object, to operate on the respective virtual object. Generation takes place off-line in so far as it takes place at a time that generally precedes steps of activation or access by the requesting subject C (producer, distributor, or dealer) or, in particular, by an end customer who has received the code Z from the requesting subject.

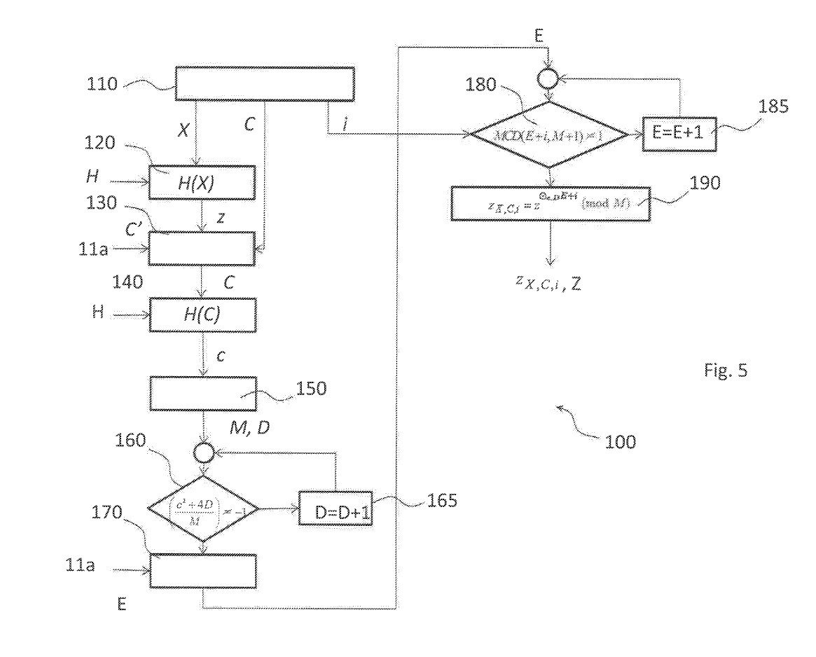

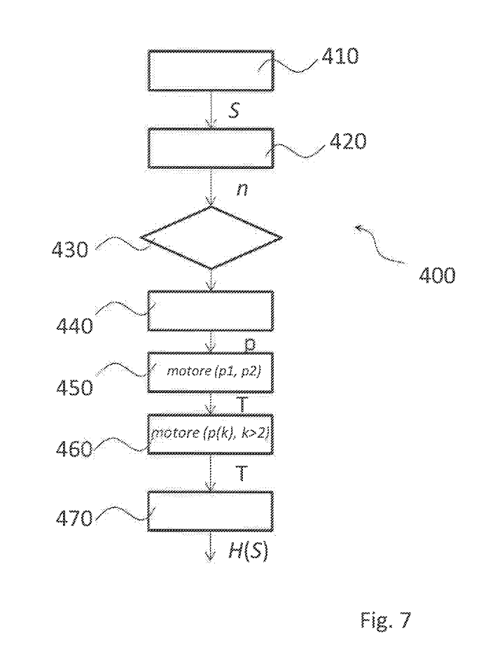

For this purpose, the node 11 implements a procedure 100 of generation of the identifier code Z, which is described more fully in what follows with reference to the procedures illustrated via the flowcharts in FIGS. 5, 6, and 7.

Furthermore, designated by the reference 12 in FIG. 1 is a factory that produces real objects R, in the example provided herein, bicycles. The firm or the subject who owns the factory 12 is identified as client C, or requesting subject, in so far as he makes a request to the management system 10 to create one or more virtual objects O, in general a plurality, for instance, a production lot, for example, of bicycles. As has been mentioned previously, in response to this request it generates identifier codes Z corresponding to each virtual object O requested. Each identifier code Z of course identifies also a given pair formed by the virtual object O and the real object R produced by the factory 12. As explained in greater detail in what follows, the identifier code Z of the virtual object O is hence generated as a function of a first value X identifying a membership class of the object O and of a second value C identifying the requesting subject, in this case the producer, and moreover as a function of a third value i representing a label that identifies the object of the client C in the class; i.e., it is an identifier code that depends upon the above three values, z_{X,C,i}.

For convenience of description, in what follows, we shall use the terms “client C”, “class X”, and “label i”, even though in general the references refer to their respective values. The class X of the virtual object O identifies the type of object, which may have different degrees of definition according to the need. The class X of the object O may, for example, be a generic type, such as “bicycle”, or else refer to a specific model of the production line, with given characteristics. The label i identifies the virtual object O in its class X; hence, it may even be a simple progressive number.

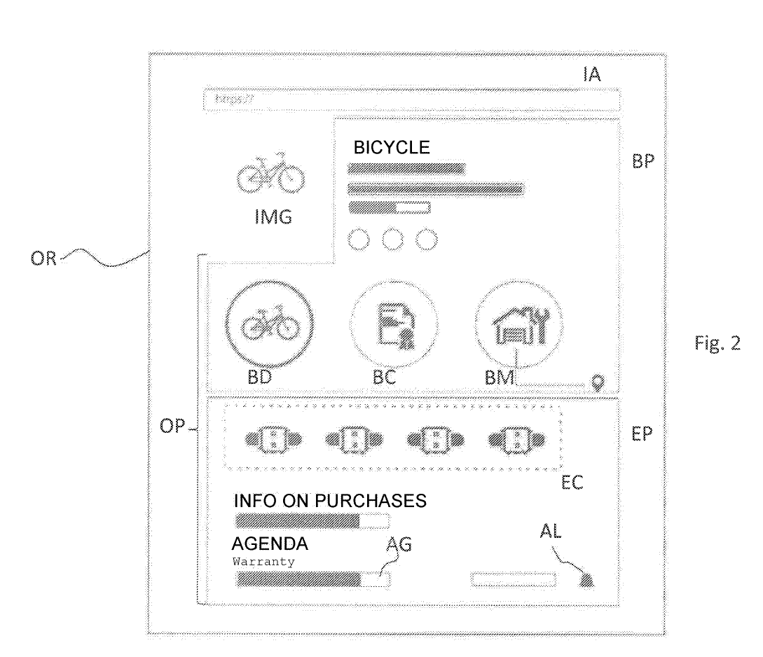

Likewise, in detailing the generation procedure in FIG. 5, reference will be made to the identifier code z_{X,C,i} that depends upon the three identifier values, X, C, i, this identifier code in any case corresponding to the identifier code Z of FIG. 2.

Furthermore, the management system 10 creates an activatable virtual object, making available, in a data structure of its own, basic information (designated by BP hereinafter in the description of FIG. 2) that regards a given virtual object O and is supplied, for example, by the requesting subject, i.e., the client C, and, for example, the values identifying the requesting subject C, the class X to which the virtual object belongs, and the label i that identifies the virtual object in the aforesaid class.

Hence, the generation node 11, as described in greater detail with reference to the method illustrated via the flowchart 100 of FIG. 5, generates an identifier code Z of the virtual object O and produces a first instance of the identifier code Z, which is sent to the management system 10, and a second instance of the identifier code Z, which is supplied to the client C.

In turn, the client C, at the moment of distribution or sale, supplies this second instance of the identifier code Z to the user U, in particular to the purchaser, of the real object R. The user U, in the example described here, is the end customer who purchases from the requesting subject C, producer, or dealer, the real object R to which the second instance of the identifier code Z is associated. However, for the purposes of the method described herein, the user U is more in general a subject who acquires the real object R and possesses the associated identifier code Z to be used through a user terminal 13 in the management system 10.

In particular, of this second instance of the code there is preferably originated a physical version to be physically associated to the real object, in particular via physical distinctive marks readable by the user terminal 13, for example, an NFC (Near-Field Communication) tag or else a QR code, or else again simple plaintext. The physical association may even be limited to a document contained in the package of the real object R or handed over together with the real object R.

This second instance of the code Z is used, in the example, by the user U, through a user terminal 13, which may be a PC, a smartphone, or some other type of terminal suitable for gaining access to the system 20 on the processing system 21, in particular of the cloud-computing type, via communication networks, for example, the Internet, to enable operations to be carried out on the virtual object O, in order to carry out activation thereof, or else, subsequently, to access the data contained in the virtual object O, for display operations, or also for operations of modification.

Also illustrated in FIG. 2 is a node 14 that represents an node for exchange of information, for example, via electronic messaging, between the user U, the client C, and the management system 20 where the object or the virtual objects O of the user U resides/reside.

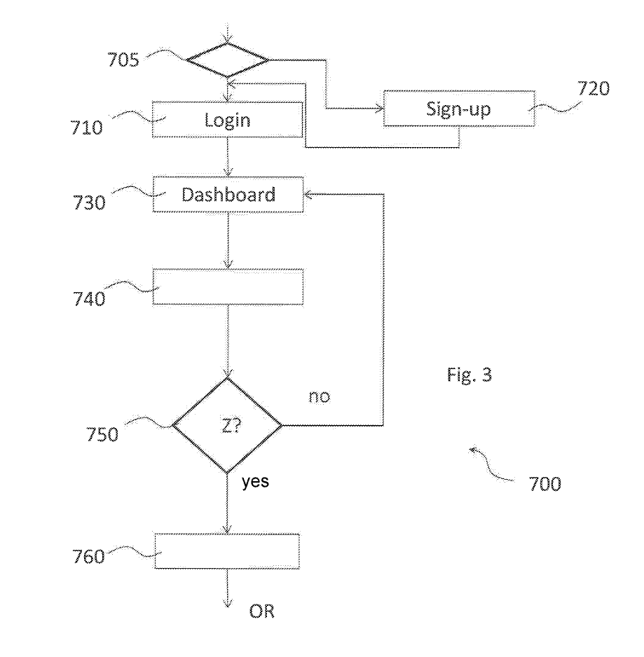

Illustrated in detail in FIG. 4 is the management system 20, which, as has been said, is implemented on a computer system 21 of an AWS-cloud type. This computer system comprises a back-end server or logic module 22, a front-end server or logic module 23, a development server or logic module 24, for enabling programmers/developers, designated by DP in FIG. 3, to intervene on the management system 20.

The back-end server 22 hosts within it the database 22a, i.e., preferably, a non-relational database that hosts the data that define the virtual objects O.

The back-end server 22 further comprises an API 22b, which includes the programs necessary for use of the management system 20 and intercepts the actions undertaken by the developers DP. Furthermore, it implements generation of the identifier codes Z of the objects; i.e., it comprises or is associated to the node 11 that executes the procedure for generation of the identifier codes Z, in particular the procedure 100 of FIG. 4.

The computer system 21 further comprises a development server or logic module, i.e., the development server 24, which includes the development environment that the programmers DP who write codes use to create new functions, using as base node.js, i.e., a platform built on JavaScript V8 runtime. This is a framework for server-side use of Javascript. The development server 24 can send programs in PH push both to the back-end 22 and to the front-end 23.

The front-end server 23 intercepts the actions undertaken by the users U external to the system 20 (by clicking on the mouse, etc.). The server reacts by launching a specific API for each action of the user U so that the system 20 will respond to the requests of the user U. The front-end 23 may, in one embodiment, be represented by an http web page, which displays the data of the object O, as illustrated in FIG. 1. In variant embodiments, it may be constituted by an application for mobile terminals, for example, for Android or IOS systems, i.e., a so-called mobile app.

The front-end server 23 communicates with the back-end server 22 querying it with requests RQ, and the back-end 22 in turn interacts with the front-end 23 by returning answers ASW. The communication between the two modules always takes place in the same way as described, except when it is the back-end 22 that has to communicate with the front-end 23, in this case by sending signals SL.

FIG. 2 is the representation of the virtual object O that resides in a computer system, in particular the computer system 21 of FIGS. 1 and 4. This virtual object O is a digital representation of a real object R that is based upon data on the virtual object O that reside in a database, in particular the database 22a illustrated in FIG. 4. In greater detail, it is a virtual representation OR, in the form of a web page, where hence designated by IA is the box dedicated to the URL address. Shown in the page OR is information, OP, regarding the object, this information comprising a basic set of information, BP, and a further set of information, EP, which, for example, comprises, as illustrated in FIG. 2, information regarding e-commerce, EC, which proposes, for example, links to commercial websites pertaining to the type of object. The page also comprises an agenda part, AG, which, for example, indicates the expiration date of a guarantee and comprises alarms AL to notify the expiration dates. As has been mentioned, the set of basic information BP is a set of initial information on the object O that a requesting subject C supplies when he asks the manager of the management system 20 for a given lot of identifier codes Z for a given real object R belonging to a given class X. The set of basic information BP may be any, but, for example, represents one or more characteristics common to the class X, for example, in the case of a bicycle, the name of the model, the type of frame and/or the type of gearchange (referred to as basic data BD in FIG. 2), as well as possibly certification data BC (for example, property or circulation certificates), or maintenance data BM (for example, maintenance coupons of a vehicle). The set of basic information BP is hence present in the system prior to activation of the virtual object O, for example, in a respective data structure that contains the name of the client C who has requested a given lot of codes Z, the list of the codes Z generated offline, and the set of basic information BP. The list of the codes Z generated offline for each code Z indicates the corresponding values that identify the requesting subject C, the class X to which the virtual object belongs, and of the label i that identifies the virtual object in the aforesaid class.

With reference to FIG. 3, which represents a flowchart of a procedure 700 of activation of a virtual object O, there are envisaged operations of access on the part of the user U to the cloud system 21, which comprise the following steps: if in a verification step 705, it is found that the user U is already registered in the services on the cloud system 21, a login step 710, which envisages supplying, for example, a “username” (e.g., the e-mail address of the user U) and a password; if in the verification step 705 the user U is not registered, a sign-up step 720, in which the user U enters, in addition to the username and password, other contact and/or profile data, such as phone number, demographic data, and other data that may be requested by the service, followed by the login step.

The above login operation 710 and the sign-up operation 720 are in any case of a conventional type, and may hence envisage, in a known way, procedures for retrieving passwords in the case where they have been forgotten and for sending supplementary verification codes to the e-mail address or via SMS (Short-Message System) for completing the sign-up step. The verification step 705 may be integrated in the login operation 710; i.e., if, for example, the username, in particular the e-mail address, is not among the ones registered, the sign-up operation 720 is started.

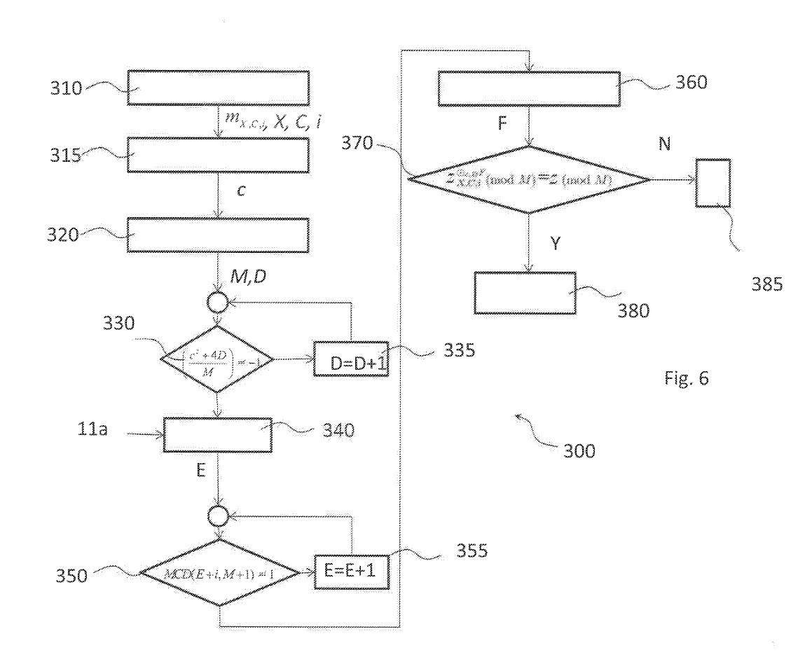

Via the login operation 710 or sign-up operation 720 a dashboard module 730 is accessed in the cloud system 21, the dashboard module 730 being an application that provides a virtual dashboard, arranged on which are graphic components, such as widgets, which launch applications. These widgets may in part regard applications supplied by the manager and in part added or removed by the user U. Specifically, the user U can operate on the dashboard 730 on a widget regarding an operation 740 of creation of a virtual object O. In this case, the user U, who has received the identifier code Z from the requesting subject C, enters the code Z in response to a request 750 of the API. A check is then made to verify that the code Z is a valid one, i.e., an identifier code Z generated via the generation procedure 100, described with reference to FIG. 5, the validity being in particular verified via the verification procedure 300, described with reference to FIG. 6. If the code is valid, an operation of activation 760 of the virtual object O corresponding to the code Z is carried out. The virtual object O is entered into the database 22a, for example, as database record, comprising, in a code field, the identifier code Z of the specific object O, and, in basic-information fields, the information of the basic set BP. The record may also contain the field that indicates the client C, or else there may be a number of databases each dedicated to a specific client C.

Since the code Z is pre-generated, i.e., generated offline, there exists in the management system 10 an association between the code Z entered by the user U and the identifier values X, C, i, which can be retrieved from the list of codes Z and entered as input values in the verification procedure 300.

Once the virtual object O has been created, it may in turn appear as widget or as icon that can be clicked on the dashboard 730, which enables access to the corresponding web page OR, preferably by repeating the step 750 of entry of the identifier code Z.

Belonging in this technological context is the procedure 100 for generating the identifier codes Z, which is implemented in the system 20 via an API, i.e., via the API module 22b in the back-end server 22. Creation of an identifier code Z of a virtual object O is in fact preferably implemented through a code portion present in the back-end server 22, in particular in the module 22b, written in node.js.

As already mentioned, this procedure 100 assigns a numerical identifier code Z to a pair constituted by a virtual object O and a real object R or good in order to enable a user terminal 13 to activate the virtual object O. The user terminal 13 is, in the example, utilized by the user U, who is the end customer, but is in general utilized by any subject who acquires the real object and hence has available the identifier code Z.

Assignment of the identifier code Z is configured so as to guarantee the following characteristics:

each object O must possess a unique identifier code Z; and

from the identifier code Z it must not be possible to trace the information regarding the user U.

The identifier code Z must enable, instead, check on the syntactic validity required in the step 750 of the activation procedure of FIG. 3, implemented via the verification procedure 300 of FIG. 6.

The method described, as already mentioned, hence identifies the identifier code Z of the object O starting from three values:

the value X, i.e., a bitstring that identifies a class X to which the object O belongs;

the value C, which is represented by a bitstring and identifies the client, or requesting subject, C; and

the value i, which represents the label i of the object O of the class X.

Starting from these three values C, X, and i, a value is calculated, namely, the identifier code Z, hereinafter denoted as to be supplied to the client C, and, through the client C, to the user U, so that the latter can gain access to the information regarding the virtual object O. The identifier code z_{X,C,i} is generated using an original cryptographic technique that is based upon definition of a product within an algebraic structure, in particular a curve E having the group structure, which is isomorphous with the set of real positives [symbol] ∪{∞}, as described hereinafter, identified starting from the values that identify the requesting subject, or client C. Generation of the identifier code z_{X,C,i} is obtained via calculation of a power, obtained from the above product defined on the algebraic structure, which identifies the object O belonging to the class X with label i, within the group structure. The cryptographic robustness of this procedure is based upon the complexity of the calculation of the discrete root in the algebraic structure introduced.

In what follows, the aforesaid procedure for generating the identifier code z_{X,C,i} will be described.

The value C identifying the client is initially used for calculating a first, seed, parameter c and a second, pseudorandom, parameter D, which determine a respective curve E(c, D), having the group structure.

The seed parameter c is determined using a hash function H and is used as seed for initialization of a pseudorandom generator (implemented, for example, in the back-end system 22, in particular in the API 22b). The pseudorandom parameter D is generated via the above pseudorandom generator. Using this technique, a single curve E is associated to the client C.

The algebraic structure defined on the curve is used for calculating the power of a value of base z, where this value is obtained by applying the hash function H to the class value X, the exponent being a function of i and X, so that it depends upon the class of the object and its label. The result of this power of the base m is the identifier code z_{X,C,i} that enables the user U to gain access to the data of the virtual object O.

The user U who wishes to gain access to the data regarding the object X with label i can use the identifier code z_{X,C,i}. The access system 20 is able to verify rapidly whether the identifier code z_{X,C,i} used by the user U is valid and, if it is, enables the user U to activate the desired virtual object O, as illustrated in FIG. 3, or else, if the virtual object O has already been activated, to gain access to the desired information of the virtual object O, for consultation or modification.

The procedure of assignment of the identifier code z_{X,C,i} is described in detail in what follows.

In a first step 110, the values X, C, i are provided as inputs, X being a bitstring (a binary bitstring consisting of 0s and 1s) that identifies the class of the object O, C being a bitstring (0s and 1s) that identifies the client, i being a number i.e., the label of the object in the class X.

In a step 120, a base value z is calculated by applying the hash function H to the class X, z=H(X). The hash function H is described in greater detail hereinafter.

In a step 130, via a pseudorandom generator 11a, for example, implemented via software in the system 21, in particular in the node 11, a pseudorandom bitstring C′ (0s and 1s) is set having a length that is the same as that of the string that represents the second value C, and the value C is substituted by its sum with the pseudorandom string, i.e., C=C+C′. This step 130, as a result of the addition of a pseudorandom value to the value C, has the effect of increasing security of the mechanism.

In a step 140, the seed parameter c is calculated by applying the hash function H to the value C obtained in the previous step, i.e., c=H(C).

In a step 150, the pseudorandom generator 11a is initialized with the seed parameter c, and, once again via the pseudorandom generator 11a, there are derived a pseudorandom prime number M, specifically, for example, in the interval [2, 2²⁵⁶], and a pseudorandom integer, i.e., the pseudorandom parameter D, specifically, for example, in the interval [1, 2¹²⁸]. Initialization of the pseudorandom generator with the seed parameter c guarantees that the pseudorandom parameters M and D depend uniquely upon the string C that identifies the requesting subject, the security of which remains guaranteed by steps 140 and 150; that is, even if the pseudorandom parameters M, D and the seed parameter c are known, it is not possible to trace back to the original string C that identifies the requesting subject, the secrecy of which remains protected. The pseudorandom parameter D, together with the seed c, has the function of determining the curve associated to the client in such a way that this curve depends exclusively upon the client but that it is not possible from this curve to trace back to the string C that identifies the requesting subject. The pseudorandom prime number M has the function of identifying the field (in a mathematical sense) in which the subsequent operations are performed. It is in fact usual, in cryptographic contexts, to carry out operations on the set of the residue classes modulo prime number, in the case in point the number M.

In a step 160, a condition on the pseudorandom parameter D, namely on the Jacobi symbol

$$( \frac{{c}^{2} + 4 D}{M} ) ,$$

is verified. In general, the Jacobi symbol

$$( \frac{a}{b} )$$

assumes the values −1, 0, +1. If the value b divides the value a, the Jacobi symbol is equal to zero; otherwise, the Jacobi symbol is equal to −1 if a is a quadratic non-residue modulo b, or else it is equal to +1 if a is a quadratic residue modulo b. In this case, the condition 160 verifies that

$$( \frac{{c}^{2} + 4 D}{M} )$$

is other than −1, i.e., that the discriminant function of the seed c and of the pseudorandom parameter D, namely, the sum of the seed c squared plus four times the parameter D, i.e., c²+4D, is a quadratic non-residue modulo M, where M is a pseudorandom integer. This step 160 corresponds to verifying that the denominator m²+hm−d in the bijections defined hereinafter for associating the curves E to a set P is not zero modulo M. Imposing this condition on the equivalent Jacobi symbol is equivalent, in fact, to having the assurance that the equation x²+cx−D=0 does not have solutions in the set of the residue classes modulo M (note that c²+4D is the discriminant of this second-degree equation). In other words, in step 160 it is verified that the seed parameter c and the pseudorandom parameter D have values such, with respect to the parameter M, as to maintain the algebraic structure with product on the curve identifying the requesting subject.

As long as this condition holds, the parameter D, in a step 165, is incremented by one, i.e.,

$$WHILE ( \frac{{c}^{2} + 4 D}{M} ) \neq - 1 , D = D + 1$$

In a step 170, the curve E is calculated, i.e., the power to which the parameter z (calculated in step 120 and depending uniquely upon the object class X is to be raised, on the curve E(c,D), initially calculating a pseudorandom integer E in the interval [1, 2⁶⁴], i.e., an initial value of curve E.

Then, in a step 180, the power E to which the parameter z is to be raised on the curve E(c,D) is generated as follows: as long as the greatest common divisor GCD between E+i and M+1 is other than unity, the value of E is incremented by 1 in a step 185, i.e.,

WHILE GCD(E+i,M+1)≠1, E=E+1

There are thus generated the values of E such that E+i is co-prime with M+1, in such a way that the exponent E+i is invertible modulo M+1, when the verification procedure 300 is carried out.

Then, in a step 190, the identifier code z_{X,C,i} is calculated as

z_{X,C,i}=z^{⊙}^{_{c,D}}^{E+i}(mod M)

⊙_{c,D} is the power on the curve E(c,D) associated uniquely to the client C. In this way, a class X of the virtual object has been associated in a unique and determinate way with the label i in that class and with the requesting subject C, in particular the client, to obtain the identifier code z_{X,C,i}. From this identifier code z_{X,C,i} it is impossible to trace back to the values X, i, and C. This code can be calculated and decrypted only by the person who possesses the information encoded in the strings X and C and in the number i.

This method hence envisages the use of an original product function deriving from a parameterization of given curves. It is to be noted that use of these curves in cryptographic contexts is not known. The above product in this context enables association to each different requesting subject of a different curve on which to perform the operations for generation of an identifier code for each object possessed by the requesting subject. In this way, an object of class X, with label i, of the requesting subject C is basically identified by a point on the curve E(c,D) (a curve which is uniquely determined by the string C identifying the requesting subject). Furthermore, from this point and this curve it is impossible to trace back to the confidential information that identifies the requesting subject and the objects possessed by the latter.

The method described herein moreover envisages the use of a hash function, designated by H and described hereinafter, which is also in itself original.

The details of implementation of the above calculation of the power ⊙_{c,D} are now described.

Definition of the Curve E

The curves E(h,d) used in what has been described previously are defined as a conic, in particular of the form

E(h,D)={(x,y)ε [symbol] ²:x²+hxy−dy²=1}

In step 190, a first parameter h of the curve, which is the coefficient of the mixed term xy, corresponds to the seed parameter c, whereas a second parameter d is the coefficient of the quadratic term in y and corresponds to the pseudorandom parameter D. Both of these parameters are calculated in a unique way starting from the value of the string C identifying the requesting subject.

These curves E(h,d) can be represented parameterically via variables y, x, using

$$y = \frac{1}{m} ( x + 1 )$$

i.e., each curve E(h,d) is in bi-unique correspondence with the set P= [symbol] ∪{∞}, i.e., each point of E(h,d) is associated to one and only one element of the set of the real positives P by means of the following bijections:

$$\{ \begin{matrix}ɛ \text{:} P -> E ( h , d ) \\ ɛ \text{:} m ↦ ( \frac{{m}^{2} + d}{{m}^{2} + hm - d} , \frac{2 m + h}{{m}^{2} + hm - d} ) ∀ m ∈ \\ ɛ ( ∞ ) = ( 1 , 0 )\end{matrix}$$

where the denominator m² hm−d, as has been mentioned previously, is nonzero, as verified via the operation 160, and

$$\{ \begin{matrix}τ \text{:} E ( h , d ) -> R \\ τ \text{:} ( x , y ) ↦ \frac{1 + x}{y} ∀ ( x , y ) ∈ E ( h , d ) , y \neq 0 \\ τ ( 1 , 0 ) = ∞ \\ τ ( - 1 , 0 ) = - \frac{h}{2}\end{matrix}$$

Product and Power Defined on the Curves E

There has previously been described the use of the product induced on the set P by the product of points of the curve E(h,d). In particular, it is defined, given a first operand a and a second operand b of the product, as a function of the first curve parameter h and the second curve parameter d. In particular, the product ⊙_{h,d} defined as follows has been used:

$$a {⊙}_{h , d} b = \frac{d + ab}{h + a + b} , if a + b \neq - h$$

$$a {⊙}_{h , d} b = ∞ , if a + b = - h$$

From this product, the power a^{}^{_{h,d}}^{b} used in what has been described previously is obtained by applying the above product b times, as follows:

$${a}^{{⊙}_{h , d} b} = \underbrace{a {⊙}_{h , d} … {⊙}_{h , d}}_{b times}$$

Therefore, in the case of the procedure 100, for the curve E, the parameters h and d are the seed c and the pseudorandom parameter D, respectively, and in step 190 the identifier code z_{X,C,i} is calculated by applying, E+i times, the product defined on the aforesaid curve.

Hence, in step 190, the identifier code z_{X,C,i} is supplied by the code-generation procedure 100; this is the value to be furnished to the client C so that the client, or preferably the user U, can activate the object of class X with label i.

There is now described a procedure 300 for checking the identifier code z_{X,C,i} that is executed on the system 21 when the user U seeks to gain access to a virtual object O.

The user terminal 13 can activate the object O of the client C, of class X with label i (or possibly gain access thereto) only if the value of the identifier code z_{X,C,i} passes the validity check implemented in the verification procedure 300. This procedure 300 of verification of the identifier code z_{X,C,i} entered by the user U is based upon the possibility by the system 20 of generating the pseudorandom numbers M, D used in the generation procedure 100 and of calculating the inverse of the exponent used for calculation of the identifier code z_{X,C,i}. In this way, it is possible for the system to trace the identifier code z_{X,C,i} of the object O and hence know whether the identifier code used by the user U is valid or not.

It should be noted that, to carry out the verification procedure 300, it is necessary for there to have been stored and kept secret in the system 20 the seed parameter c associated to the client C obtained in the generation procedure 100.

According to what has been described with reference to the procedure 100, if the requesting subject C who is entering the number is known, the seed parameter c is known (since it is stored), and hence the values M, D, and E are also known, without any need to store them in so far as they are pseudorandom numbers with seed c.

Hence, the procedure 300, in a step 310, receives at input the value z_{X,C,i} i.e., the value entered by the user U in step 750, as well as the three values C, X, and i. The identifier values X, C, i, as has been said, can be retrieved from the code list Z and entered as input values in the verification procedure 300.

In a step 315, it is envisaged to initialize a pseudorandom generator with the seed c.

In a step 320, once again via a pseudorandom generator, there are obtained the pseudorandom prime number M, specifically in the interval [2, 2²⁵⁶], and the pseudorandom integer parameter D, specifically in the interval [1, 2¹²⁸], i.e., the same values as those of step 150.

In a step 330, as in step 180, a condition on the pseudorandom parameter D, namely, on the Jacobi symbol

$$( \frac{{c}^{2} + 4 D}{M} ) ,$$

is verified, the condition being that the Jacobi symbol is other than −1. If it is, the parameter D is incremented by 1, i.e.,

$$WHILE ( \frac{{c}^{2} + 4 D}{M} ) \neq - 1 , D = D + 1$$

In a step 340, as in step 190, the curve E is calculated by computing a pseudorandom integer E in the interval [1, 2⁶⁴].

Then, in a step 350, the curve E(c,D) is generated as follows: if the greatest common divisor GCD between E+i and M+1 is other than unity, the value of curve E is incremented by 1 (step 355), i.e.,

WHILE GCD(E+i,M+1)≠1, E=E+1

Then, in a step 360 a value F is calculated as

F=(E+i)⁻¹(mod M+1)

In a step 370, it is verified whether z_{X,C,i}^{⊙}^{_{c,D}}^{F} (mod M)=z(mod M), i.e.,

IF z_{X,C,i}^{⊙}^{_{c,D}}^{F} (mod=z(mod M) THEN return(TRUE) ELSE return(FALSE)

If the test on equality yields a positive result, the verification procedure 300 returns the value TRUE, the identifier code z_{X,C,i} entered by the user U is considered correct, and hence the system 20 enables the user U, in a step 380, to access the virtual object O. Otherwise, the code is considered not correct, and the system 20 (step 385) does not allow access to the object O.

Described in detail in what follows is the hash function H, which is in itself original and is based upon a further function motore, described hereinafter.

The above hash function H is based upon the Chinese Remainder Theorem (CRT), which is applied to a symmetric-key cryptographic system in the way described in what follows. The subjects A and B, who wish to exchange a message MSG, share two secret large prime numbers p<q. The message MSG is divided into two blocks M1 and M2 such that q<M1 and M2<pq. The subject A calculates, using the CRT, a value V such that V mod p=M1 and V mod q=M2. The subject A sends the value V to the subject B. The person who intercepts the value V knows only that V=M1+kp and V=M2+hq; hence, this person is unable to determine the value V. Instead, the subject B knows the values p, q and can derive the blocks RI, M2. The computational cost of this procedure is almost zero; however, it may be vulnerable to a plaintext attack in so far as, if the blocks M1 and M2 are known, C-M1 and C-M2 can be factored, thus easily obtaining the values p and q, which are large prime numbers. For this reason, it is envisaged to change always the key in order to render the procedure safe. The hash function H described herein is hence defined on the basis of these concepts. Cryptographic functions are in fact frequently used to produce hash functions, using iterative methods (Merkle-Damgård hashing). To be used they must be good pseudorandom generators. The hash function H described herein is particularly suited because it spreads out the statistics in an optimal way. Changing one bit in the input string entails on average the change of one half of the bits at output. This basic scheme, as shown hereinafter, is moreover modified with operations that render computationally impossible ad-hoc creation of collisions (by appropriate “cutting” and “pasting” of bitstrings).

There is now described in detail the calculation of the hash function H with reference to the flowchart 400.

Supplied in a step 410 is an input bitstring (i.e., a binary string) S, which in the code-generation process 100 corresponds to the string that represents the class X in the application of the hash function H in step 120, or to the string that represents the requesting subject C in the application of the hash function H in step 140, as described with reference to the previous FIGS. 4 and 5.

In a step 420, an integer n is set at the value 256, and an integer m is set at a value equal to the length of the string S.

In a step 430, it is verified whether n [symbol] m, i.e., whether the integer n is a divisor of the integer m.

If it is, in a step 435, the number of zeros necessary to obtain n|m is added at the end of the string S. If it is not, the process continues without any intervention on the string S.

In a step 440, a vector of sublists p is defined as

p=Partition(S,n)

i.e., p is a vector containing sublists of length n of the string S (i.e., p(1) is the sequence of the first n bits of S, p(2) is the list of the next n bits of S, etc.).

The steps 410-440 just described are used for carrying out partition into sublists p(k), and then calculating the hash function H by applying a number of times, via the function motore, described in detail hereinafter, applied to each sublist p(k), the procedure based upon the Chinese Remainder Theorem.

Hence, in a step 450, there is hence set a value T of the binary hash function, via the function motore applied to the first two elements, p(1) and p(2) of the vector p, i.e., to the first two sublists. T in fact is a string of 0s and 1s, i.e., a base-2 number:

T=motore(p(1),p(2))

In a step 460, a calculation of the value of the binary hash function T is carried out using the function motore on all the remaining elements of the vector p, from 3 to m/n.

FOR k=3 TO m/n DO T=motore(T,p(k))

In a step 470, the hash function H(S) is computed as decimal representation of T. Hence, in step 470, there is supplied at output the calculation of the hash function H, with value expressed in base 10.

Described moreover in detail hereinafter is the function motore that is used in the calculation of the hash function, in step 450 and in the iterative step 460, and implements the Chinese Remainder Theorem.

Supplied at input are two bitstrings (of 0s and 1s) of the same length, i.e., the operands l, g, which in step 450 are the sublists p(1) and p(2) and in step 460 are the current value of the binary hash function T and the k-th sublist p(k), and at output the bitstring corresponding to a new current value of the binary hash function T is returned.

In particular, a value n is defined equal to the length of the operand l and, if the value n is even, the operation a₁=Take(l, n/2) is performed, where the function Take(x, n) returns the first n elements of the generic string x. Hence, the first n/2 elements of the string l, i.e., of the first operand, are taken.

Then, the operation m₁=Drop(l, n/2) is performed. The function Drop(x, n) returns the list x without the first n elements.

Next, the function PrependTo(m₁, 1) is calculated, where the function PrependTo(x, n) returns the list x to which the element n has been added at its start.

Then, the operations a₂=Take(g, n/2) and m₂=Drop (g, n/2) and PrependTo(m₂, 1) are performed.

If, instead, the value n is even,

$${a}_{1} = Take ( l , \frac{n - 1}{2} )$$

$${m}_{1} = Drop ( l , \frac{n - 1}{2} )$$

$${a}_{2} = Take ( g , \frac{n - 1}{2} )$$

$${m}_{2} = Drop ( g , \frac{n - 1}{2} )$$

There are then computed ā₁, ā₂, m̅₁, m̅₂, as decimal representations of a₁, a₂, m₁, m₂, respectively.

There follows calculation of the two greatest common divisors of the pairs of decimal representations of the parts obtained with the functions Take and Drop, i.e., of the initial part and the final part of the operands, dₐ=GCD(ā₁, ā₂) and GCD(m̅₁, m̅₂).

There is assigned r as solution of the following system of congruences

$$\{ \begin{matrix}x ≡ \frac{{\overline{a}}_{1}}{{d}_{a}} ( mod \frac{{\overline{m}}_{1}}{{d}_{m}} ) \\ x ≡ \frac{{\overline{a}}_{2}}{{d}_{a}} ( mod \frac{{\overline{m}}_{2}}{{d}_{m}} )\end{matrix}$$

The solution r is obtained using the Chinese Remainder Theorem.

There is defined s as base-2 representation of the solution r of length 2n.

There is defined s′ as being equal to s in inverted order.

Next, the position index v=ā₁(mod n)+1 is determined.

Then, s″ is defined as being equal to s′ without the element at the position index v just calculated.

Finally, the value of the binary hash function T is calculated as T=Take (s″, n).

The method described presents the advantages outlined in what follows.

The method described herein carries out assignment of a numerical identifier code to a real object or good, enabling a single subject who acquires the real object to have available the information on that given real object, i.e., to activate the virtual object.

The method described carries out an assignment of the identifier code that guarantees that:
each virtual object possesses a unique identifier code;
the identifier code enables a syntactic check (operation 750) on the code Z entered by the user U to be carried out by the virtual-object management system, in particular by the provider/manager of the system;
from the identifier code it is not possible to trace back to the information regarding the user U.

Hence, the method described causes for there to be generated, in the database, a unique assignment between the object and the code that enables the end user to possess and hence manage the virtual avatar of his own real object. Furthermore, the system manager derives, from the control of use of the code, information that can be used for storing and processing “big data”. Finally, the client, i.e., the distributor, can interact with the purchaser of the object directly through a one-to-one marketing channel.

Advantageously, the identifier code is generated using an original cryptographic technique that is based upon definition of a product within an algebraic structure defined starting from the value that identifies the client.

Advantageously, generation of the identifier code is obtained via calculation of appropriate powers that identify an object belonging to a given class with a given label within the aforesaid algebraic structure. In this way, the procedure presents a cryptographic robustness, deriving principally from the complexity of the calculation of a discrete root in the algebraic structure introduced. The difficulties linked to the complexity of the discrete root render the procedure presented usable for the creation of a public-key cryptographic code.

Of course, without prejudice to the principle of the invention, the details and the embodiments may vary, even considerably, with respect to what has been described herein purely by way of example, without thereby departing from the sphere of protection, which is defined in the annexed claims.

It is emphasized how, in the example of embodiment, the identifier code is calculated as a function of a value, C, identifying the client that possesses and markets the real object, who supplies the identifier code to the user U. However, more in general, the value C may identify a subject who is to be authorized for access, who could even be the user himself, in the case where he is known at the moment of encoding.

The method described is aimed at managing access of users to virtual objects that represent real objects. The definition of real object to which this method applies is not limited to material objects or goods, but may also include immaterial goods. Moreover, this definition of real object may include not only inanimate objects, but also animals or persons, for which a corresponding “virtual object” may be defined. It follows that this real object is not necessarily managed by the system following upon a commercial operation. By way of example, there may exist a virtual object corresponding to a dog or a horse, or else a virtual object corresponding to a person (for example, in the case where a person wants to become a member of a golf club, at the moment of applying for membership in the club, he or she is assigned, along with an identifier code, a virtual object that represents the person as a golfer, along with the relevant statistics, schedules of golfing events, and other specific functions).

In the case of an animal, such as a dog, the corresponding virtual object may contain photographs and contents linked thereto, and also, via a system of notifications, schedules for administration of medicines and vaccinations, which are notified when the virtual object is accessed (or possibly the virtual object makes these notifications by sending messages, such as e-mails).

It is possible to assign a unique identifier code to a common object already present in everyday life, even without it having been purchased from a dealer who supplies the code together with the object at the moment of the purchase, such as an item of clothing. In other words, the real objects are not always purchased from a dealer or produced by a manufacturer who originally entered the identifier code according to the method described herein. The method also applies in the case where the code is assigned a posteriori on already existing objects. Consequently, the present method is not moreover limited to activities that involve purely commercial transactions, but extends to all those activities that may require supply to users of real objects that are represented by a corresponding virtual object.

1. A method for managing virtual objects (O) corresponding to real objects (R), said virtual objects (O) comprising a set (OP) of information or data representing said real object (R),
said virtual objects (O) residing in a management system comprising a computer system accessible by user terminals through a telecommunication network to enable operations to be carried out on said virtual objects (O) in a database in said computer system, said method comprising the operations of:
generating in response to a request of a requesting subject (C) to create one or more virtual objects (O) that represent respective real objects (R), corresponding unique identifier codes (Z, z_{X,C,i}) that enable a user terminal to carry out operations on the respective virtual object (O),
said method being characterized in that:
said unique identifier codes (Z, z_{X,C,i}) enable a user terminal to carry out a procedure of activation of the respective virtual object (O), associating in the database, included in said computer system, a unique identifier code (Z, z_{X,C,i}) to a first basic set (BP) of information, which in particular is supplied by said requesting subject (C) at the moment of the request,
said identifier code (z_{X,C,i}) being calculated on the basis of:
a first value (X) identifying a class to which the virtual object (O) belongs;
a second value (C) identifying said requesting subject;
a third value (i) representing a label that identifies said virtual object (O) in said class (X).

2. The method according to claim 1, wherein:
said operation of calculating the identifier code (z_{X,C,i}) comprises:
defining an algebraic structure (E, P) defined on the basis of said second value (C) that identifies a requesting subject and defining a product operation (⊙_{h,d}) in said algebraic structure (E, P); and
generating said identifier code (z_{X,C,i}) by computing a power, obtained on the basis of said product (⊙_{h,d}) defined in said algebraic structure (E, P), that identifies the virtual object (O) distinguished by the first value (X) identifying a class and by the third value (i) representing a label in said algebraic structure (E, P).

3. The method according to claim 2, wherein said operation of defining an algebraic structure (E, P) on the basis of said second value (C) that identifies a requesting subject comprises:
using said second value (C) that identifies a requesting subject for calculating pseudorandom parameters (c, D) that identify a curve (E(c, D)) with group structure, a first parameter (c) of said pseudorandom parameters (c, D) representing a seed for initialization of a pseudorandom generator determined by applying a hash function (H) to said second value (C) that identifies the requesting subject, and a second parameter (D) being generated via said pseudorandom generator initialized with said first, seed, parameter (c) in order to associate a single curve (E(c, D)) to a given requesting subject (C).

4. The method according to claim 3, wherein it comprises calculating, via the algebraic structure defined on the curve (E(c, D)), the power of a base value (z) obtained by applying the hash function (H) to the first value (X) that identifies a class, where the exponent depends upon said third value (i) representing a label that identifies said virtual object (O) in the class (X), the result of said calculation corresponding to said identifier code (z_{X,C,i}).

5. The method according to claim 4, wherein said operation of generating unique identifier codes (z_{X,C,i}) comprises:
sending said first, second, and third identifier values (X, C, i);
calculating a base value (z) by applying a hash function (H) to the class (X);
setting a pseudorandom string (C′) and substituting the second value (C) with its sum with said pseudorandom string (C′);
calculating a seed parameter (c) by applying the hash function (H) to said second value (C);
using said seed parameter (c) for initializing a pseudorandom generator and obtaining, once again via said pseudorandom generator, a pseudorandom prime number (M) and a pseudorandom integer (D);
verifying that said seed parameter (c), said pseudorandom prime number (M), and said pseudorandom integer (D) have values such as to maintain said algebraic structure (E, P) with product, and, as long as this is true, incrementing said pseudorandom integer (D);
generating values of curve (E) such that its sum (E+i) with the label value (i) is invertible modulo said pseudorandom integer (M) plus one; and
calculating said identifier code (z_{X,C,i}) as said base value (z) used in said power obtained on the basis of said product (⊙_{h,d}) defined in said algebraic structure (E, P) that has as exponent said sum (E+i).

6. The method according to claim 1, wherein said hash function (H) comprises partitioning into sublists (p(k)) a binary string, which in particular corresponds to said first identifier value (X) or said second identifier value (C), and calculating the hash function (H) by applying to each of said sublists a procedure that comprises calculating, on the basis of the sublist, a system of congruences and computing the solution of said system of congruences using the Chinese Remainder Theorem (CRT).

7. The method according to claim 2, wherein said curve (E(c, D)) has the form of a parametric conic (E(h, d)) having a first curve parameter (h), in particular corresponding to the first, seed, parameter (c), and a second curve parameter (d), in particular corresponding to the pseudorandom integer (D), in particular defined as:
E(h,d)={(x,y)Σ [symbol] ²:x²+hxy−dy²=1}

8. The method according to claim 2, wherein said product (⊙_{h,d}) is defined, given a first operand (a) and a second operand (b) of the product, as a function of said first curve parameter (h) and said second curve parameter (d), in particular as
$$a {⊙}_{h , d} b = \frac{d + ab}{h + a + b} , if a + b \neq - h$$
$$a {⊙}_{h , d} b = ∞ , if a + b = - h$$

9. The method according to claim 1, wherein said unique identifier codes (Z, z_{X,C,i}) moreover enable a user terminal to gain access to said virtual object (O) once activated.

10. The method according to claim 1, wherein said unique identifier codes (Z, z_{X,C,i}) are physically associated to the real object (R), in particular via physical distinctive marks that can be read by said user terminal.

11. The method according to claim 1, wherein, following upon said request, said first value (X) identifying a class to which the virtual object belongs (O), said second value (C) identifying said subject (C), said third value (i) representing a label that identifies said virtual object (O) in said class (X), and said first basic set of information (BP) are made available in the management system.

12. A system for management of virtual objects (O) corresponding to real objects (R), said virtual objects (O) comprising a set (OP) of information or data representing said real object (R), said system comprising a computer system accessible by user terminals through a telecommunication network to enable operations to be carried out on said virtual objects (O) in a database in said computer system,
said computer system comprising a module for generating, in response to a request of a requesting subject (C) to create one or more virtual objects (O) that represent respective real objects (R), corresponding unique identifier codes (Z, z_{X,C,i}) that enable a user terminal to carry out operations on the respective virtual object (O),
said system being wherein:
it is configured for implementing the method according to claim 1.

13. The system according to claim 12, wherein it comprises a back-end server that includes said database and said module for generating a unique identifier code (z_{X,C,i}) and a front-end server for intercepting the commands of the users (U).

14. A computer program product that can be loaded into the memory of at least one computer, the computer program product comprising portions of software code for implementing the method according to claim 1 when it is run on said at least one computer.
